(19) United States
(12) Patent Application Publication
(10) Pub. No.: US 2005/0133525 A1
(43) Pub. Date: Jun. 23, 2005

(54) Lockout device for viscous liquid dispenser

(76) Inventors: Richard Paul Lewis, Marietta, GA (US); Randall Marc Bachtel, Duluth, GA (US)

Correspondence Address: KIMBERLY-CLARK WORLDWIDE, INC., 401 NORTH LAKE STREET, NEENAH, WI, 54956, US

(21) Appl. No.: 10/745,755

(22) Filed: Dec. 23, 2003

(51) Int. Cl. G01F 11/00

(52) U.S. Cl. 222/1; 222/153.03

(57) ABSTRACT

A self-contained viscous liquid dispenser including a leak protection lockout device is provided. The dispenser includes a housing defining a liquid reservoir, a pump cylinder, a pump cylinder actuator operably connected to the housing; and a tool removably and rotatably attached to the pump cylinder. In use, contact between the actuator and the pump cylinder causes liquid to dispense from the pump cylinder. The tool includes a lockout member that substantially inhibits contact between the actuator and the pump cylinder. The leak protection lockout device is particularly suited to prevent leaks during shipment or extended storage of the dispenser.

### BACKGROUND OF THE INVENTION

Viscous liquid dispensers are well known in the art for dispensing any manner of viscous liquid, for example lotions, soap, and the like. The conventional dispensers utilize a wide variety of pumping mechanisms that allow a user to depress or manipulate a pump actuator in order to dispense liquid from the dispenser. Exemplary devices are shown, for example, in U.S. Pat. Nos. 5,810,203; 5,379,919; 5,184,760; and 4,174,056.

Conventional dispensers and pump mechanisms are often configured with locking mechanisms to reduce leakage during shipment or storage. However, locking mechanisms may fail to fully stop leakage, especially in those pumps having a pump mechanism at or below the level of the liquid in the dispenser. During shipping or other transport of the dispenser, vibration or other movement of the pump actuator can often result in partial activation of the pump mechanism that results in undesirable leakage.

Therefore, there remains a need in the art for a dispenser with improved capability to prevent leakage during shipment thereof.

### SUMMARY OF THE INVENTION

Advantages of the invention will be set forth in part in the following description, or may be obvious from the description, or may be learned through practice of the invention.

The present invention provides a dispenser having a leak protection lockout device that is particularly well suited for viscous liquid dispensers, for example, soap dispensers, lotion dispensers, and the like. The leak protection device is particularly suited to prevent leaks during shipment or extended storage of the dispenser.

In accordance with one embodiment of the present invention, a dispenser for dispensing metered amounts of a viscous liquid is disclosed that includes a housing defining a liquid reservoir, a pump cylinder, a pump cylinder actuator operably connected to the housing; and a tool removably and rotatably attached to the pump cylinder, the tool including a lockout member, wherein the lockout member substantially inhibits actuation of the pump cylinder. The pump cylinder is slidably disposed and retained in a pump chamber and includes a first opening in communication with the reservoir, a second opening in communication with the exterior of the housing, and a dispensing channel disposed therebetween and through the cylinder. The pump cylinder is slidable and rotatable within the pump chamber between a locking position and a dispensing position. Desirably, substantially the entire tool is positioned between the housing and the actuating member.

In one aspect, the pump cylinder rotating tool may further include a head portion and a handle portion attached to the head portion. The handle may include a central recessed portion that may additionally include openings having shapes such as, for example, a directional arrow. The head portion is removably attached to the pump cylinder, while the lockout member extends from the head portion. The head portion may include first and second jaws defining an inside surface shaped to removably attach to an exterior portion of the pump cylinder. The first and second jaws may include inwardly projecting hooks, while the exterior portion of the pump cylinder may define notches sized and shaped for engagement by the inwardly projecting hooks. Desirably, the first and second jaws resiliently flex to permit removal of the tool from the cylinder.

In a further aspect, the pump cylinder extends from a front wall of the pump mechanism, while the lockout member extends further from the front wall than the pump cylinder. Desirably, the end of the lockout member is further from the front wall of the pump mechanism than the end of the pump cylinder is from the front wall of the pump mechanism.

In an even further aspect, the tool further includes at least one extension member attached to and extending from the head portion. Desirably, the tool further includes at least two extension members attached to and extending from the head portion. Even more desirably, the tool further includes first and second extension members attached to and extending from the first jaw, and third and fourth extension members attached to and extending from the second jaw. Desirably, the extension members present contact the front wall of the pump mechanism. The extension members are desirably substantially rigid to resist buckling upon contact between the actuator and the lockout member. Additionally, the extension members may resiliently flex during rotation of the tool about the axis of the pump cylinder.

In a still further aspect, rotation of the tool about the axis of the pump cylinder causes rotation of the pump cylinder from the locking position to the dispensing position. Desirably, continued rotation of the tool about the axis of the pump cylinder past the position where the pump cylinder reaches the dispensing position thereof results in separation of the tool from the pump cylinder.

In accordance with another embodiment of the present invention, a leak-resistant dispenser in condition for shipping is disclosed that includes a housing defining a liquid reservoir, a pump cylinder having a first opening in communication with the reservoir, a second opening in communication with the exterior of the housing, and a dispensing channel disposed therebetween, a pump cylinder actuator operably connected to the housing; and a pump cylinder rotating tool removably attached to the pump cylinder. The tool includes a means for substantially preventing contact between the actuator and the pump cylinder. The pump cylinder is rotatably disposed and retained in a pump chamber at a locking position and is rotatable to a dispensing position.

Desirably, the actuator comprises an inside surface defining a notch aligned to engage the means for substantially preventing contact between the actuator and the pump cylinder upon activation of the actuator.

In accordance with still another embodiment of the present invention, a method of removing a lockout device from a self-contained viscous liquid dispenser is disclosed that includes the steps of:

providing a dispenser including a housing defining a liquid reservoir, a pump cylinder having a first opening in communication with the reservoir and a second opening in communication with the exterior of the housing, a pump cylinder actuator operably connected to the housing; and a tool removably and rotatably attached to the pump cylinder, the tool comprising a lockout member that substantially inhibits actuation of the pump cylinder;

rotating the tool about the axis of the pump cylinder to rotate the pump cylinder to the dispensing position; and

continuing to rotate the tool until the tool disengages from the pump cylinder.

The invention will be described in greater detail below through embodiments illustrated in the figures.

### BRIEF DESCRIPTION OF THE DRAWINGS

FIG. 1 is a prospective view of a viscous liquid dispenser according to the invention;

FIG. 2 is a cross sectional view of the pump mechanism taken along the lines indicated in FIG. 1;

FIG. 3a is a partial perspective and cross sectional view of an embodiment of the pump mechanism;

FIG. 3b is a partial perspective and cross sectional view of the pump mechanism shown in FIG. 3a particularly illustrating a locking feature thereof;

FIG. 4 is a partial perspective view of an embodiment of the pump mechanism;

FIG. 5 is a prospective view of a leak protection device according to the present invention;

FIG. 6 is a partial cross sectional operational view of an embodiment of the dispenser;

FIG. 7 is a partial cross sectional operational view of the leak protection device.

### DETAILED DESCRIPTION

Reference will now be made in detail to embodiments of the invention, one or more examples of which are provided in the drawings. Each example is provided by way of explanation of the invention and not meant as a limitation of the invention. For example, features illustrated or described as part of one embodiment may be utilized with another embodiment to yield still a further embodiment. It is intended that the present invention include such modifications and variations as come within the scope of the appended claims and their equivalents.

The present invention relates to a leak protection device for use with any manner of user activated liquid dispenser. The leak protection device is particularly well suited for use with any manner of viscous liquid dispenser, for example soap dispensers, lotion dispensers, and the like. The present invention also encompasses a dispenser utilizing the leak protection device according to the invention. Examples of dispensers that may benefit from the leak protection device of the present invention are described in WO 02/49490 A1 as well as U.S. Pat. No. 6,516,976 to Lewis et al., U.S. Pat. No. 6,533,145 to Lewis et al., U.S. Pat. No. 6,543,651 to Lewis et al., U.S. Pat. No. 6,575,334 to Lewis et al., and U.S. Pat. No. 6,575,335 to Lewis et al., and U.S. patent application publications 2002/0074354A1 and 2002/0074355A1, the entireties of which are incorporated herein by reference.

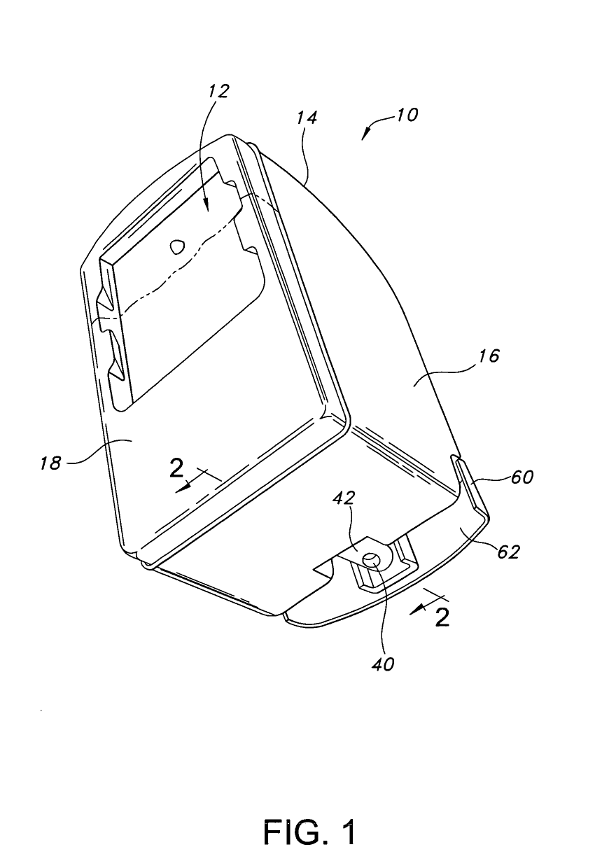

FIG. 1 illustrates a viscous liquid dispenser 10 that is particularly suited as a liquid soap dispenser. The dispenser 10 comprises a housing, generally 14. The housing 14 may comprise any number of components. For example, the housing 14 may include a front housing member 16 that is connected to a back housing member 18. The dispenser 10 illustrated in FIG. 1 is configured as a disposable liquid soap dispenser that can be removably attached to a wall mounted bracket or the like. For this purpose, mounting structure, generally 12, is integrally formed on the back side 18 of the housing 14. Desirable wall mounting brackets, for example, are disclosed in concurrently filed U.S. patent application Ser. No. ______, Express Mail Number EL 955701957 US, docket number 19422, the entirety of which is incorporated herein by reference.

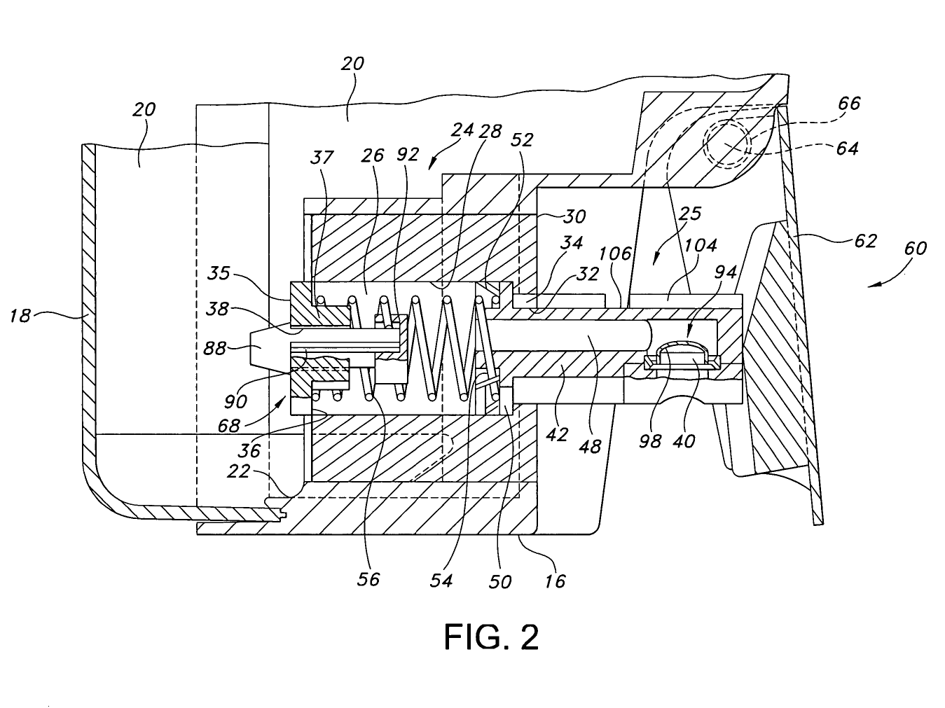

Referring to FIG. 2, the dispenser 10 includes a liquid reservoir, generally 20 (FIG. 2). A dosing pump is configured with the dispenser to dispense metered doses of the viscous liquid contained within the reservoir 20 upon a user depressing or manipulating a pump actuator. The pump actuator may be any structural member that is configured with or connected to a pump mechanism to dispense the viscous liquid from the dispenser 10. The pump mechanism will be described in greater detail below. In the illustrated embodiments, the pump actuator, generally 60, is illustrated as a panel member 62. The panel member 62 adds to the aesthetically pleasing overall configuration of the dispenser 10 and may take on any shape. The panel member 62 is pivotally attached to the front component 16 of the housing 14 by way of protrusions 64 that reside in recesses 66 defined in the front component 16.

The dosing pump apparatus 24 includes a channel 28 defining a pump chamber 26 defined by any manner of structural components. For example, wall members that are molded or otherwise formed on an internal surface, i.e., the bottom surface 22 of the housing 14, may define the pump chamber 26. In this embodiment, the pump chamber 26 is thus disposed completely within the housing 14. In alternate embodiments, structural wall members that are attached to the outside surface of the housing member by any conventional means may define the pump chamber. In either case, the pump chamber 26 is in liquid communication with the reservoir 20. For example, the pump chamber 26 may include a back wall 36 having an opening 38 defined therethrough and placing the pump chamber 26 in liquid communication with the reservoir 20. In the embodiment of FIG. 2, an end cap member 35 having the opening 38 defined therethrough defines the back wall 36 of the pump chamber 26. This configuration may be used when it is necessary to insert the pump mechanism into the pump chamber 26 prior to sealing the chamber 26.

The pump chamber 26 has an internal volume that essentially defines the metered amount or dose of liquid to be dispensed therefrom. In this regard, the pump chamber can be configured with any desired volume depending on the intended use of the dispenser 10.

A dispensing orifice 40 is also provided in the pump chamber 26 and defines the exit path for the viscous liquid from the pump chamber 26. In the embodiment illustrated in FIG. 2, the dispensing orifice 40 is defined in a member of the pump mechanism, particularly a cylinder 42 that extends through an opening 32 in a front wall 30 of the pump chamber 26. The pump mechanism of FIG. 2 will be described in greater detail below. Other desirable pump mechanisms, for example, are disclosed in copending U.S. patent application Ser. No. 10/675,034, filed Sep. 30, 2003, the entirety of which is incorporated herein by reference.

As mentioned, the pump apparatus 24 includes a pump mechanism 25 that is operably configured with the pump chamber 26 to pressurize the viscous liquid contained within the pump chamber upon a user actuating the pump mechanism. Various configurations of devices may be utilized in this regard. For example, the pump mechanism 25 may be a cylinder member 42 that is slidable within the pump chamber 26, as illustrated in FIG. 2. The cylinder 42 extends through an opening in the front wall 30 of the pump chamber and is prevented from being pulled out of the chamber 26 by a flange or piston member 50. The piston member 50 also sealingly engages against the walls of the pump chamber 26. An O-ring may be provided on the piston member 50 for this purpose. The cylinder 42 has a longitudinal dispensing channel 48 defined therethrough. The channel 48 terminates at the dispensing end of the cylinder 42 at the dispensing orifice 40. Thus, in this embodiment, the dispensing orifice 40 is actually defined in the moveable pump cylinder 42.

The cylinder 42 is moveable from a rest position to a pressurized or dispensing position. The cylinder 42 is biased to its rest position by any conventional device, for example a spring 56 disposed within the pump Express Mail: EL 955701815 US Docket Number: 19,371 chamber 26. The spring 56 has a forward end fitted in a recess 54 defined by a conical flange member 52. The rear end of the spring 56 is fitted around a cylindrical extension 37 of the end cap member 35.

Still referring to FIG. 2, the actuator 60 configured as a panel member 62 is disposed in close proximity to the forward end of the cylinder 42 so that upon a user depressing the panel member 62 from the front side of the dispenser 10, the cylinder 42 is caused to move rearward within the pump chamber 26. As the cylinder 42 moves into the pump chamber 26, a check valve mechanism (described in greater detail below) seals the opening 38 in the rear wall 36 of the pump chamber in response to an increase in liquid pressure within the chamber. As the pressure of the liquid increases within the chamber, the liquid is eventually dispensed out of the dispensing orifice 40. In the embodiment of FIG. 2, the liquid is caused to travel through the longitudinal channel 48 to be dispensed out of the dispensing end of the cylinder 42.

Upon release of the actuator 60, the cylinder 42 is caused to return to its rest position. As the cylinder moves to the right, a vacuum is drawn within the pump chamber 26 that causes the check valve mechanism to unseat. Liquid from the reservoir 20 is then free to flow into the pump chamber 26 to be dispensed upon the next subsequent actuation of the pump mechanism.

As mentioned, a check valve mechanism, generally 68, is operably disposed in the opening 38 between the pump chamber 26 and the reservoir 20 to seal the opening upon actuation of the pump mechanism 25. The check valve mechanism 68 may be, for example, an elongated shuttle valve 88. The shuttle valve 88 is slidable within the opening 38 in the end cap member 35 and has a plurality of radially extending arms 90. Liquid from the reservoir 20 is free to flow past the arms 90 and into the pump chamber 26 so long as the shuttle valve 88 is not sealed against the opening 38. In that regard, the shuttle valve 88 includes a cap 92 that sealingly engages against the end cap member 35 upon actuation of the pump mechanism 25. The cap 92 prevents the liquid contained within the reservoir 20 from escaping through the opening in the chamber 26 and back into the reservoir 20 upon actuation of the pump mechanism 25. Upon release of the pump mechanism 25, the shuttle valve 88 moves into the chamber 26 and thus unseals the opening 38. The static head pressure of the liquid within the reservoir 20 should be sufficient to cause the shuttle valve 88 to unseat and move into the pump chamber 26 to allow the chamber 26 to refill with liquid from the reservoir 20. The vacuum drawn in the chamber 26 upon return of the cylinder 42 to its rest position will further aid unseating of the shuttle valve 88. Other types of check valves known to those skilled in the art may be used.

The pump apparatus also includes a restriction device, generally 94, operably disposed across the dispensing orifice 40. The restriction device 94 may include at least one resilient flap member 98, and desirably a plurality of flap members 98 defined by slits (not shown). The resilient flaps 94 have a concave configuration, and the restriction device 94 is disposed within the dispensing orifice so that the concave flaps are oriented upwards or towards the pump chamber 26. Upon sufficient pressure within the pump chamber 26, the liquid causes the resilient flaps 98 to buckle towards the dispensing orifice 40, and the liquid flows through the dispensing orifice 40. Upon release of the pump mechanism 25 and return of the mechanism to its rest position, the resilient flaps move back into engagement against themselves. However, due to the vacuum drawn in the pump chamber as the pump mechanism returns to its rest position, the flaps are pulled slightly apart and towards the pump chamber 26. The flaps move apart just enough so that the pump chamber is vented as the pump mechanism 25 returns to its rest position. Once the pump mechanism 25 has returned to its rest position, the flaps 98 again completely seal against each other and prevent leakage or drippage of liquid from the pump chamber.

The restriction device 94 provides a relatively simple means of reducing leakage from the pump chamber, particularly in embodiments of the invention wherein the pump chamber is horizontally disposed at the bottom portion of the pump reservoir where static pressure of the liquid within the reservoir is greatest. The restriction device 94 also provides a relatively simple means for venting the pump chamber 26 and eliminates the need to vent the pump mechanism around the pump shaft or cylinder that may result in leakage problems. Additionally, the pump mechanism may be incorporated with unvented dispensers since a vent path is defined through the pump mechanism. If a vent is needed, desirable vent mechanisms, for example, are disclosed in concurrently filed U.S. patent application Ser. No. _______, Express Mail Number EL 955701965 US, docket number 19372, the entirety of which is incorporated herein by reference.

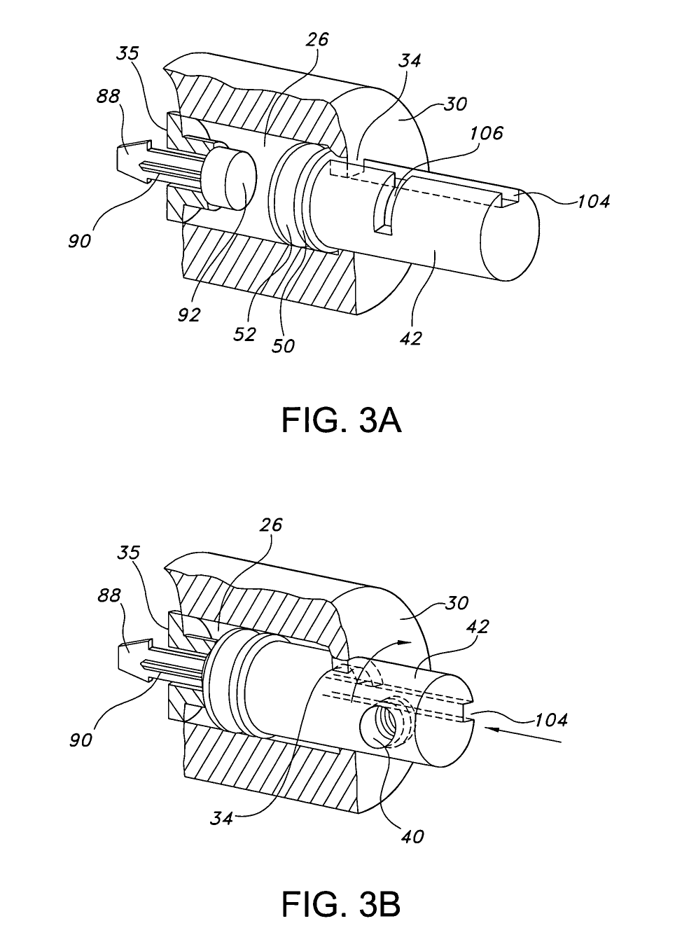

FIGS. 3a and 3b illustrate a locking feature of the cylinder 42. A longitudinal channel 104 is defined in the top surface of the cylinder 42 and is engaged by a tab 34 of the front wall 30. The cylinder 42 thus slides along the tab 34 upon depression of the actuator 60 and is prevented from rotating in use. The orientation of the dispensing orifice 40 is thus ensured. A partial circumferential groove 106 is also defined in the surface of the cylinder 42. The groove 106 is located at a position that corresponds essentially to the fully depressed position of the cylinder 42. Once the cylinder 42 has been fully depressed, the cylinder 42 may be rotated such that the tab 34 engages the groove 106. The cylinder 42 is then locked into position. This locking feature is particularly useful during shipment of the dispenser.

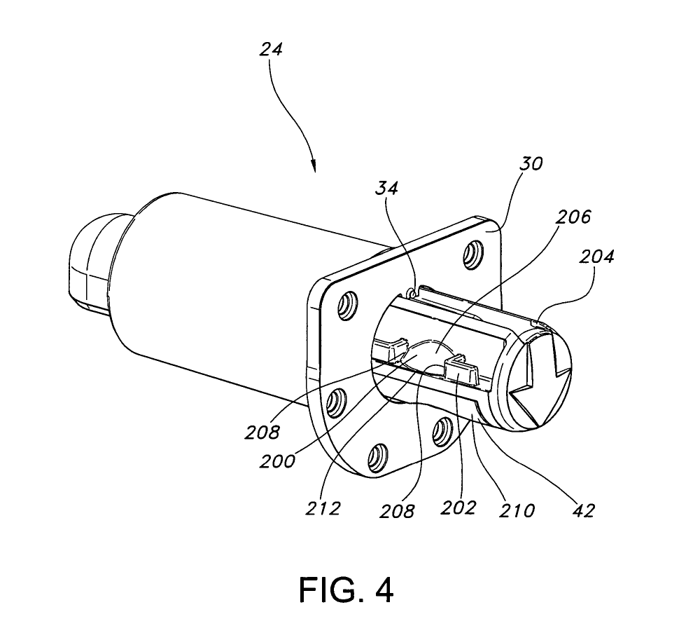

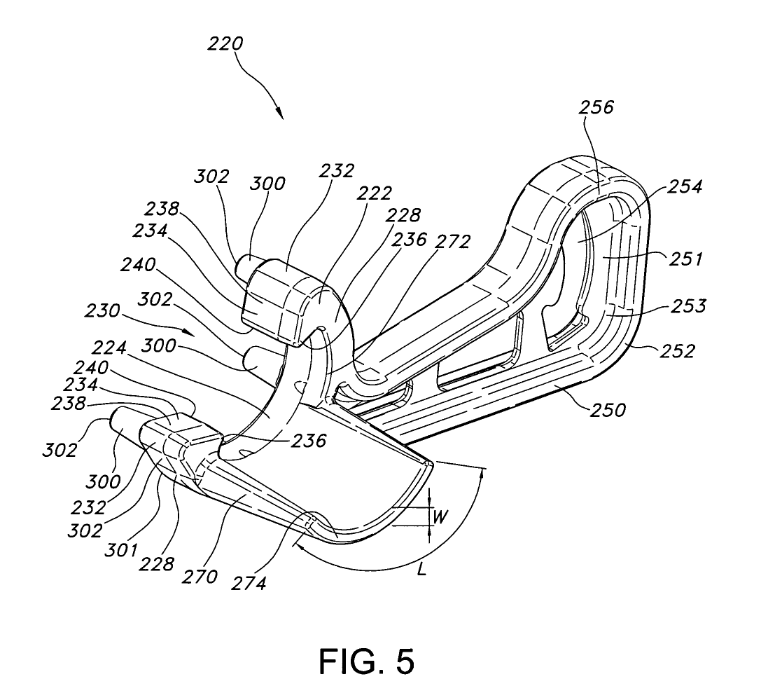

FIG. 4 illustrates an additional feature of the cylinder 42 of the pump apparatus 24. Notches 200 are defined upon a first side 202 and a second side 204 opposed to the first side of the cylinder 42 at first and second edges 212. The notches 200 are shaped to accept and engage the jaws of a tool (see FIG. 5) designed to facilitate rotation of the cylinder 42 into and out of its locked position. The notches 200 have an engagement surface 206. The engagement surface 206 is angled such that a sufficient force applied to the engagement surface will have a radial component that will cause the cylinder 42 to rotate into or out of its locked position. The notches 200 may have side surfaces 208 that are useful for aligning and maintaining the jaws of the tool in the correct position along the length of the cylinder 42.

FIG. 5 illustrates an embodiment of a tool that may be used to rotate the pump cylinder 42 into or out of its locked position. The tool or wrench 220 includes a head portion 222 having first and second jaws 228. The jaws 228 together define an inside surface 224. The inside surface 224 is desirably shaped to fit closely around an exterior portion 210 of the cylinder 42 disposed between the notches 200 on the cylinder. The jaws 228 define a gap 230 therebetween that is sized to accept the exterior portion 210 disposed between the notches 200 on the cylinder 42. At an end 232 of each jaw 228 is disposed an inwardly projecting hook 234. The hooks 234 have an engaging surface 236 that extends from and partially faces the inside surface 224 of the head portion 222. Desirably, the engaging surfaces 236 are disposed substantially perpendicular to the inside surface 224 of the head 222. When the tool or wrench 220 is installed on the cylinder 42, the engaging surfaces 236 on the hooks 234 contact the complementary engagement surfaces 206 in the notches 200 on the cylinder 42. When the tool 220 is rotated about the axis of the cylinder 42, the interaction between the engagement surface 206 and the engaging surface 236, as well as that between the inside surface 224 of the head portion 222 and the exterior portion 210 on the cylinder, causes the cylinder 42 to rotate about its axis.

On the end 232 of each jaw 228 is an outwardly facing surface 238. On each jaw 228, between the engaging surface 236 and the outwardly facing surface 238 is a tip 240. The distance between the tip 240 on the first jaw and the tip 240 on the second jaw is less than the distance between the first and second edges 212 of the notches 200 on the cylinder 42. Thus, as the tool 220 is installed on the cylinder 42, the outwardly facing surfaces 238 on the ends 232 of each jaw 238 contact the edges 212 of the notches 220 on the cylinder. As the tool is pushed against the cylinder 42, the jaws 228 temporarily flex outwardly until the tool snaps into place, allowing the hooks 234 to engage the notches 200 on the cylinder.

The tool 220 further includes a handle or grip portion 250. The handle portion 250 may be grasped and used to rotate the cylinder 42 to its open or closed position. The handle portion 250 may also be grasped and used to place or remove the tool 220 on or from the cylinder 42 of the dispenser 10. The handle 250 is desirably of sufficient length to allow a user to readily develop sufficient torque to rotate the cylinder 42. However, the handle 250 is also desirably compact enough to fit under the actuator 60 so as to not extend from the housing 14 and add to the overall size of the dispenser 10. The handle 250 may have any shape that is easily grasped by a user. In a desirable embodiment, the handle has a recessed central portion 251 with a ridge 252 at its periphery 253 to reduce the likelihood of the handle slipping from the fingers of a user. The recessed central portion 251 may define openings 254. The openings 254 may have the shape of a directional arrow. The handle 250 may have an expanded portion 256 at the end of the handle for ease of grasping.

The tool 220 further includes a lockout member 270. The lockout member 270 is attached to and extends from an upper surface 272 of the wrench 220. The lockout member extends past the end of the cylinder 42 when the wrench 220 is installed on the cylinder. An end 274 of the lockout member 270 is positioned such that activation of the actuator 60 while the wrench 220 is present on the dispenser 10 results in the actuator contacting the end of the lockout member rather than contacting the end of the pump cylinder 42. The lockout member 270 is desirably shaped to match the shape of the head portion 220. The lockout member 270 desirably has a length “L” sufficiently long that the lockout member will readily prevent accidental contact of the actuator 62 with the pump cylinder 42. The lockout member 270 desirably has a width “W” sufficiently wide to prevent deflection or buckling of the lockout member that may result in contact of the pump cylinder 42 by the actuator 60 despite the presence of the lockout member.

The tool 220 further includes one or more lockout extension members 300. In a particularly desirable configuration, the tool 220 includes four lockout extension members 300. The lockout extension members 300 are attached to and extend from a lower surface 301 of the tool 220. Desirably, the lockout extension members 300 are attached to and extend from the head portion 222. Even more desirably, tool 220 includes two lockout extension members 300 that extend from each of the first and second jaws 228. The lockout extension members 300 provide additional support to the tool 220 while it is removably attached to the cylinder 42. The lockout extension members 300 have ends 302 that contact the front panel 30 of the pump apparatus 24 when the tool 220 is installed on the cylinder 42. The lockout extension members 300 are sufficiently rigid to substantially prevent deflection or buckling upon application of force by the actuating mechanism 60. However, the lockout extension members 300 desirably will deflect slightly to the side to facilitate rotation of the tool 220 and/or installation or removal of the tool.

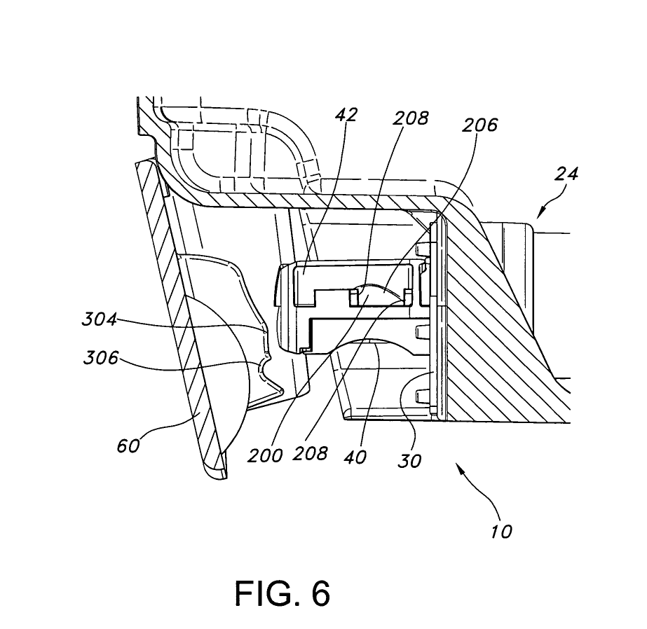

FIG. 6 illustrates an embodiment of the dispenser 10. The dispenser 10 has a hingedly attached actuator 60. In operation of the dispenser 10, actuation of the actuator 60 causes an inside surface 304 of the actuator to contact the end of the pump cylinder 42 and depress the cylinder in the pump apparatus 24 to cause flow of liquid from the dispensing orifice 40 defined in the cylinder extending from the front wall 30 of the pump mechanism.

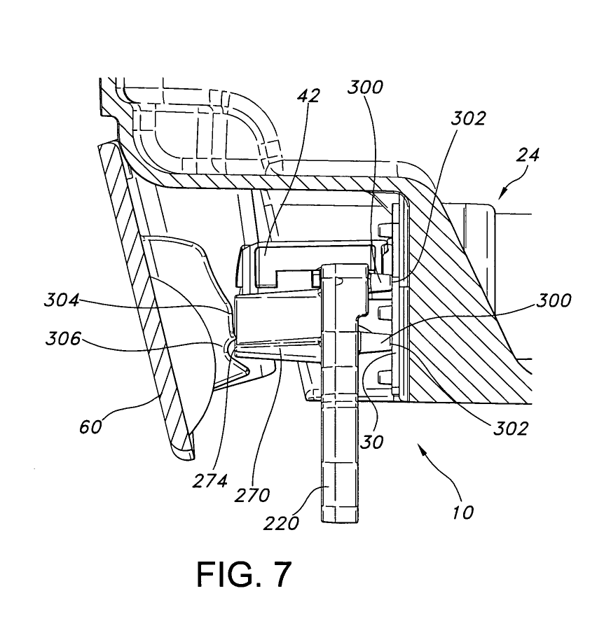

FIG. 7 illustrates the operation of the leak protection device on the dispenser. When the tool 220 is installed on the dispenser 10, activation of the actuator 60 causes the inside surface 304 of the actuator to contact the lockout member 270 rather than the end of the pump cylinder 42. A notch 306 desirably defined on the inside surface 304 of the actuator 62 may be positioned to engage the end 274 of the lockout member 270. The notch 306 substantially prevents the actuator 62 from slipping from the end 274 of the lockout member 270. Additionally, the notch 306 substantially prevents the tool 220 from moving laterally after the actuator 60 engages the lockout member 270. The ends 302 of the lockout extension members 300 contact the front wall 30 of the pump apparatus 24 to anchor the tool 220. When the tool 220 is in place, the tool substantially prevents the actuator 60 from contacting and moving the pump cylinder 42, thus substantially reducing the potential for leakage. However, after installation of the dispenser 10 at its intended destination, the tool 220 is readily used to unlock the pump cylinder 42 as described above and then removed from the pump cylinder 42 to enable normal operation of the dispenser.

It should be appreciated by those skilled in the art that various modifications or variations can be made in the invention without departing from the scope and spirit of the invention. It is intended that the invention include such modifications and variations as come within the scope of the appended claims and their equivalents.

1. A dispenser for dispensing metered amounts of a viscous liquid, the dispenser comprising:
a housing defining a liquid reservoir;
a pump cylinder having a first opening in communication with the reservoir and a second opening in communication with the exterior of the housing, wherein the pump cylinder is slidably disposed and retained in a pump chamber, further wherein the pump cylinder has a dispensing channel disposed therethrough, and further wherein the pump cylinder is slidable and rotatable within the pump chamber between a locking position and a dispensing position;
a pump cylinder actuator operably connected to the housing; and
a tool removably and rotatably attached to the pump cylinder, the tool comprising a lockout member, wherein the lockout member substantially inhibits actuation of the pump cylinder.

2. The dispenser as in claim 1, wherein the pump cylinder rotating tool further comprises a head portion and a handle portion attached to the head portion, wherein the head portion is removably attached to the pump cylinder, and wherein the lockout member extends from the head portion.

3. The dispenser as in claim 2, wherein the head portion comprises first and second jaws defining an inside surface shaped to removably attach to an exterior portion of the pump cylinder.

4. The dispenser as in claim 3, wherein the first and second jaws comprise inwardly projecting hooks, and wherein the exterior portion of the pump cylinder defines notches sized and shaped to engaged by the inwardly projecting hooks.

5. The dispenser as in claim 3, wherein the first and second jaws resiliently flex to permit removal of the tool from the cylinder.

6. The dispenser as in claim 2, wherein the tool is positioned between the housing and the actuator.

7. The dispenser as in claim 2, wherein the handle comprises a recessed central portion defining an opening shaped as a directional arrow.

8. The dispenser as in claim 2, wherein the pump cylinder extends from a front wall of the pump mechanism, and further wherein the lockout member extends further from the front wall than the pump cylinder.

9. The dispenser as in claim 8, wherein the end of the lockout member is further from the front wall of the pump mechanism than the end of the pump cylinder is from the front wall of the pump mechanism.

10. The dispenser as in claim 1 wherein the lockout member is shaped to substantially match the shape of the pump cylinder.

11. The dispenser as in claim 2, wherein the tool further comprises at least one extension member attached to and extending from the head portion, and further wherein the extension member contacts the front wall of the pump mechanism.

12. The dispenser as in claim 2, wherein the tool further comprises at least two extension members attached to and extending from the head portion, and further wherein the extension members contact the front wall of the pump mechanism, and further wherein the extension members are substantially rigid to resist buckling upon contact between the actuator and the lockout member.

13. The dispenser as in claim 12, wherein the extension members resiliently flex during rotation of the tool about the axis of the pump cylinder.

14. The dispenser as in claim 1, wherein the actuator comprises an inside surface defining a notch aligned to engage the lockout member upon activation of the actuator.

15. The dispenser as in claim 3, wherein the tool further comprises first and second extension members attached to and extending from the first jaw, and further wherein the tool further comprises third and fourth extension members attached to and extending from the second jaw.

16. The dispenser as in claim 1, wherein rotation of the tool about the axis of the pump cylinder causes rotation of the pump cylinder from the locking position to the dispensing position.

17. The dispenser as in claim 16, wherein continued rotation of the tool about the axis of the pump cylinder past the position where the pump cylinder reaches the dispensing position thereof results in separation of the tool from the pump cylinder.

18. The dispenser as in claim 1, wherein the locking member substantially inhibits contact between the actuator and the pump cylinder.

19. A leak-resistant dispenser in condition for shipping, the dispenser comprising:
a housing defining a liquid reservoir;
a pump cylinder having a first opening in communication with the reservoir, a second opening in communication with the exterior of the housing, and a dispensing channel disposed therebetween, wherein the pump cylinder is rotatably disposed and retained in a pump chamber at a locking position, and further wherein the pump cylinder is rotatable to a dispensing position;
a pump cylinder actuator operably connected to the housing; and
a pump cylinder rotating tool removably attached to the pump cylinder, the tool comprising a means for substantially preventing contact between the actuator and the pump cylinder.

20. The dispenser as in claim 19, wherein the actuator comprises an inside surface defining a notch aligned to engage the means for substantially preventing contact between the actuator and the pump cylinder upon activation of the actuator.

21. A method of removing a lockout device from a self-contained viscous liquid dispenser, the method comprising the steps of:
providing a dispenser comprising:
a housing defining a liquid reservoir;
a pump cylinder having a first opening in communication with the reservoir, a second opening in communication with the exterior of the housing, and a dispensing channel disposed therebetween, wherein the pump cylinder is slidably disposed and retained in a pump chamber, and further wherein the pump cylinder is rotatable within the pump chamber between a locking position and a dispensing position;
a pump cylinder actuator operably connected to the housing; and
a tool removably and rotatably attached to the pump cylinder, the tool comprising a lockout member, wherein the lockout member substantially inhibits actuation of the pump cylinder;
rotating the tool about the axis of the pump cylinder to rotate the pump cylinder to the dispensing position; and
continuing to rotate the tool until the tool disengages from the pump cylinder.
